(19) United States
(12) Patent Application Publication
(10) Pub. No.: US 2010/0053181 A1
(43) Pub. Date: Mar. 4, 2010

(54) METHOD AND DEVICE OF PROCESSING VIDEO

(75) Inventors: Erik M. Schlanger, Austin, TX (US); Brendan D. Donahe, Lago Vista, TX (US)

Correspondence Address: Vista IP Law Group LLP, 1885 Lundy Avenue Suite 108, San Jose, CA, 95131, US

(73) Assignee: RAZA MICROELECTRONICS, INC., Cupertino, CA (US)

(21) Appl. No.: 12/202,285

(22) Filed: Aug. 31, 2008

(51) Int. Cl. G09G 5/39

(52) U.S. Cl. 345/531; 375/240.24

(57) ABSTRACT

A memory controller is disclosed that allocates local memory space to a set of macroblocks of a picture being processed. Information associated with a specific macroblock of the set of macroblocks is written to non-local memory when it is no longer needed to complete processing of a current row of macroblocks. When information associated with the specific macroblock is later needed to process a different row of macroblocks, the memory controller allocates local memory space to the specific macroblock and stores the previously saved information from non-local memory to the local memory.

### FIELD OF THE DISCLOSURE

The present disclosure relates to video processing and more particularly to a device and method of processing video data.

### BACKGROUND

High-definition (HD) signals typically require a high-definition television or other device in order to be viewed. With an aspect ratio of 16:9 (1.78:1), HD video approaches current aspect ratios of regular widescreen film recorded at typically 1.85:1 or 2.40:1 (sometimes traditionally quoted at 2.35:1). Standard-definition (SD) video differs from HD video by having an aspect ratio of 4:3 (1.33:1). Numerous video standards and formats have emerged to output HD and SD video. However, each format presents unique characteristics and specifications. As such, processing of video, such as the decoding and encoding of video, for different video standards can be limited by the ability of a device to efficiently process the video data.

### BRIEF DESCRIPTION OF THE DRAWINGS

Embodiments incorporating teachings of the present disclosure are shown and described with respect to the drawings presented herein, in which:

FIG. 1 is a block diagram representing a device in accordance with a specific embodiment of the present disclosure;

FIG. 2 is a block diagram representing the bit stream acceleration module of FIG. 1 in greater detail in accordance with a specific embodiment of the present disclosure;

FIG. 3 illustrates a configuration of macroblock buffers within memory 15 in accordance with a specific embodiment of the present disclosure;

FIG. 4 illustrates a macroblock array of a picture being processed in accordance with a specific embodiment of the present disclosure;

FIG. 5 illustrates a macroblock partitioned to have 16 picture blocks;

FIG. 6 illustrates a macroblock partitioned to have 6 picture blocks;

FIG. 7 is a block diagram representing neighbor block control module 115 of FIG. 1 in greater detail in accordance with a specific embodiment of the present disclosure;

FIG. 8 illustrates a flow diagram representing a method in accordance with a specific embodiment of the present disclosure;

FIG. 9 illustrates a table containing macroblock status information in accordance with a specific embodiment of the present disclosure;

FIG. 10 illustrates a table containing macroblock status information in accordance with a specific embodiment of the present disclosure;

FIG. 11 illustrates is a block diagram representing a portion of FIG. 7 in greater detail in accordance with a specific embodiment of the present disclosure;

FIG. 12 illustrates a flow diagram representing a method in accordance with a specific embodiment of the present disclosure;

FIG. 13 illustrates is a block diagram representing a portion of FIG. 11 in greater detail in accordance with a specific embodiment of the present disclosure;

FIG. 14 illustrates a table containing status information in accordance with a specific embodiment of the present disclosure;

FIG. 15 illustrates a table containing status information in accordance with a specific embodiment of the present disclosure;

FIG. 16 illustrates a table containing status information in accordance with a specific embodiment of the present disclosure;

FIG. 17 illustrates a flow diagram representing a method in accordance with a specific embodiment of the present disclosure;

FIG. 18 illustrates a table containing macroblock status information in accordance with a specific embodiment of the present disclosure;

FIG. 19 illustrates a table containing status information in accordance with a specific embodiment of the present disclosure;

FIG. 20 illustrates a table containing status information in accordance with a specific embodiment of the present disclosure;

FIG. 21 illustrates a table containing macroblock status information in accordance with a specific embodiment of the present disclosure;

FIG. 22 illustrates a macroblock array of a picture being processed in accordance with a specific embodiment of the present disclosure;

FIG. 23 illustrates a macroblock array of a picture being processed in accordance with a specific embodiment of the present disclosure;

FIG. 24 illustrates a flow diagram representing a method in accordance with a specific embodiment of the present disclosure.

### DETAILED DESCRIPTION

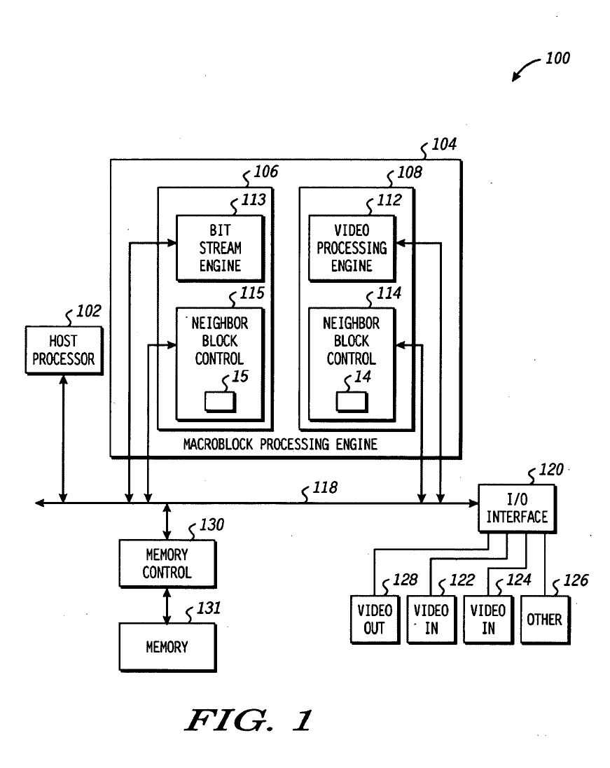

A memory controller is disclosed that allocates local memory space to a set of macroblocks of a picture being processed. Information associated with a specific macroblock of the set of macroblocks is written to non-local memory when it is no longer needed to complete processing of a current row of macroblocks. When information associated with the specific macroblock is later needed to process a different row of macroblocks, the memory controller allocates local memory space to the specific macroblock and stores the previously saved information from non-local memory to the local memory. Various embodiments of the present disclosure will be better understood with reference to FIGS. 1-24.

FIG. 1 is a block diagram of a video processing system of a device 100 according to a particular embodiment of the disclosure. The device 100 includes the video processing system illustrated at FIG. 1, and can be realized as a mobile or non-mobile device. Device 100 can be a handheld electronic device having a self contained power supply. The video processing system 100 can process various digital video standards such as h.264, MPEG (“Moving Pictures Expert Group”) 1, 2, and 4, JPEG (Joint Picture Experts Group), MJPEG (“Motion JPEG”), DV (“Digital Video”), WMV (“Windows Media Video”), VC-1, RM (“Real Media”), DivX, Sorenson 3, Quicktime 6, RP9, WMV9, AVS, Ogg Theora, Dirac, or various other formats and code/decode specifications (codecs).

The video processing system illustrated at FIG. 1 includes a host processor 102, a macroblock processing engine (MPE) 104, I/O interface module 120, video in module 122, video in module 124, video out module 128, other modules 126, memory control module 130, and memory 131. An interconnect 118 connects the host processor 102, MPE 104, I/O interface 120, and memory control module 130 to facilitate the communication of information.

The host processor 102 is operable as a central processing unit (CPU) that can include one or more core processors capable of executing an operating system, software applications, and the like.

The MPE 104 includes a bit stream acceleration module 106 and a video processing module 108. The bit stream acceleration module 106 includes a bit stream engine 113 and a neighbor block control module 115. The bit stream acceleration module 106 performs various processing functions on a received video stream, provides access requests to memory control module 130, and provides information access requests to neighbor block control module 115 to access memory 15. The video processing module 108 includes a video processing engine 112 that performs various video processing functions on the processed video from bit stream acceleration module 106 and provides requests to access information to memory control module 130 and to neighbor block control 114.

The neighbor block control modules 114 and 115 are specialized memory controllers that process client requests by applying a set of neighbor rules for a current video standard to determine where to access information related to a neighbor of an identified macroblock. In addition, the neighbor block control modules 114 and 115 allocate macroblock buffers to a portion of the macroblocks of a picture being processed by its corresponding processing engine. Operation of a neighbor block control module will be discussed by example with reference to the bit stream accelerator module 106.

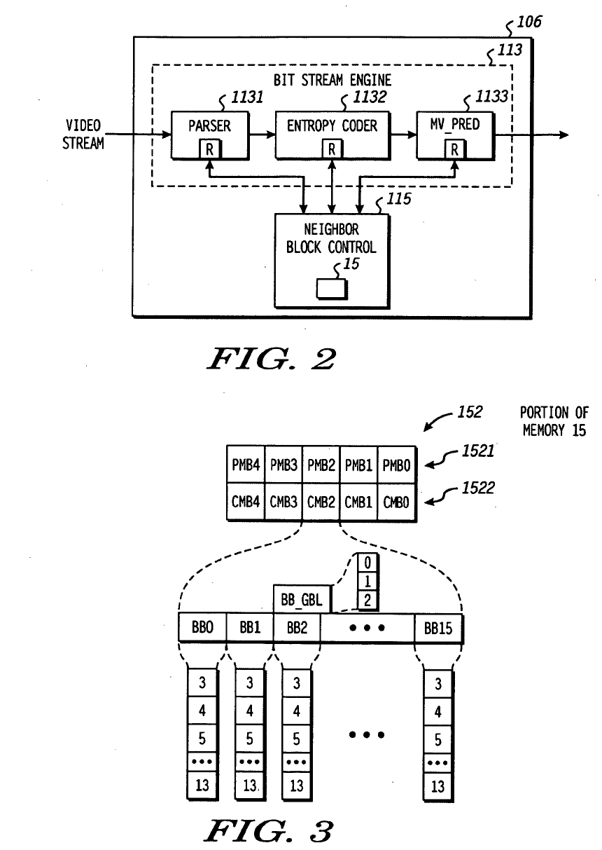

FIG. 2 illustrates a block diagram of the bit stream acceleration engine 106 in greater detail, where the bit stream engine 113 includes three modules: a parser 1131; an entropy coder module 1132; and a motion vector prediction module (MV_PRED) 1133. The data processor modules 1131-1133 are referred to as clients of the neighbor block control module 115 because they can submit requests to the neighbor block control module 115 as described herein. Each of the data processor modules 1131-1133 are illustrated to include a corresponding set of registers labeled “R”. With respect to a video decode operation, a video stream is received at parser module 1131 for parsing. Information parsed at parser module 1131 is received at entropy coder module 1132 for entropy decoding. Information entropy coded at entropy coder module 1132 is received at MV_PRED 1133 for motion vector prediction.

The neighbor block control module 115 receives access requests from the plurality of clients at bit stream acceleration module 106 to access information associated with various macroblocks of a picture being processed. An access request to neighbor block control module 115 from a client includes a lookup portion, e.g., a lookup access request, that is used by the neighbor block control module 115 to determine a desired picture block, and an access portion, e.g., a read or write access request, that is used by the neighbor block control module 115 to access information associated the desired picture block that is stored at a local memory. Note that the terms picture block and block are used interchangeably, herein, and refers to a specific partition of a macroblock. The lookup portion of an access request to the neighbor block control module 115 includes neighbor block information, and information identifying a picture block of the picture being processed, referred to as the identified picture block. The neighbor block information identifies either a neighbor block direction indicating a direction to a picture block other than the identified block relative the identified picture block, or the identified picture block. The neighbor block control module 115 allocates macroblock buffers to macroblocks of a picture being processed to maintain a sliding window of of macroblock buffers at the picture being processed that can be accessed by its clients. The term macroblock buffer is intended to refer to memory that stores information related to a macroblock of a picture. Macroblocks buffers of the neighbor block control module 115 that reside at memory 15 will be better understood with respect to the particular embodiment of FIG. 3.

Referring to FIG. 3, the configuration of macroblock buffers within memory 15 is illustrated in greater detail. Memory 15 is partitioned to include a plurality of macroblock buffers 152 that store macroblock information for macroblocks of a picture being processed by the clients of neighbor block control module 115, where the macroblock information includes picture reconstruction information that will be needed by the clients of neighbor block control module 115 to complete picture processing.

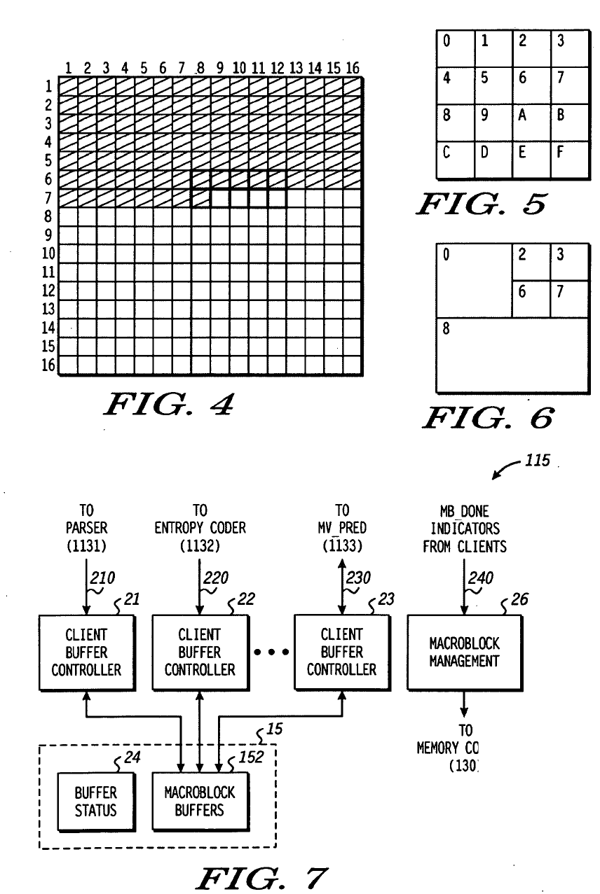

Macroblock buffers 152 include a set of macroblock buffers 1521 and a set of macroblocks 1522. The set of macroblock buffers 1522 includes macroblock buffers labeled CMBB0-CMBB4 that can be allocated to macroblocks that reside in a common row of macroblocks of a picture, referred to as the current row of macroblocks, where picture processing is currently being performed by the neighbor clients. For example, FIG. 4 illustrates a picture having sixteen rows of macroblocks, labeled 1-16, and 16 columns of macroblocks, labeled 1-16, where the macroblocks having bold borders at row 7 represent macroblocks to which macroblock buffers CMBB0-CMBB4 are presently allocated. The set of macroblock buffers 1521 includes macroblock buffers labeled PMBB0-PMBB4 that can be allocated to macroblocks that reside in a common row of macroblocks, referred to as the previous row of macroblocks, that was processed the clients of neighbor block control module 115 prior to the current row of macroblocks being processed. The macroblocks having bold borders at row 6 represent macroblocks to which macroblock buffers PMBB0-PMBB4 are presently allocated. Note that at FIG. 4, the macroblocks of rows 1 through 6, and the first eight macroblocks of row 7, are shaded to indicate those macroblocks having been completely processed by clients of neighbor block control module 115. For example, only a portion of the current row of macroblocks, row 7, is shaded since the current row is still being processed. For purposes of discussion, an individual macroblock of FIG. 4 can be identified herein using the prefix MB and listing its column and row locations within. For example, the top left macroblock having a bold border is referred to herein as macroblock MB[8,6], or just MB[8,6].

FIG. 3 further illustrates that each macroblock buffer of the macroblock buffers 152 includes a global block buffer (GBB) and 16 individual block buffers (BB0-BB15) that are also referred to as block buffers. The global block buffer contains fields for storing information that are accessible when any one of the 16 individual block buffers has been selected by a lookup access request, while each individual block buffer contains storage fields that are accessible only when that individual block buffer has been selected by a lookup access request. For example, referring to FIG. 3, an access to field locations 0-2 will result in an access to the global block buffer regardless which one of the block buffers BB0-BB15 of block buffer CMBB2 is being accessed, however an access to field locations 3-13 will result in an access to a unique set of field locations 3-13 that are associated only with the specific individual block buffer selected by the lookup access request. Fields accessible by a block buffer can be dedicated for storing specific data provided by a specific neighbor client. For example, fields 1, 3 and 4 can store information from the parser 1131, fields 2 and 5-7 can store information from entropy coder module 1132, and fields 3 and 8-13 can store information from motion vector prediction module 1133.

Each block buffer of a macroblock buffer will be associated with a specific block of a macroblock when the macroblock is partitioned to have sixteen 4×4 blocks. For example, FIG. 5 illustrates a 16×16 macroblock partitioned to have sixteen 4×4 blocks, each 4×4 block having a corresponding 4×4 block location, labeled 0-F, respectively. As such, information associated with the 4×4 block at 4×4 block location 0 would be stored at block buffer BB0, information associated with the 4×4 block labeled 1 would be stored at block buffer BB1, and so on, with information associated with the 4×4 block at 4×4 block location F would be stored at block buffer BBF.

When a macroblock is partitioned to have blocks of different sizes, each block can be identified by its partition type, and its top-left most 4×4 block location. For example, the macroblock illustrated at FIG. 6 includes four 4×4 blocks, one 8×8 block, and one 16×8 block. The 8×8 blocks are referred herein using the designator B followed by a partition type indicator and 4×4 location designator in brackets. For example, the 8×8 block of FIG. 6 is referred to as block B[8×8,0], where 8×8 indicates the block is an 8×8 block, and the 0 indicates the block's top-left most 4×4 location. Similarly, the 4×4 blocks of FIG. 6 are referred to as B[4×4,2], B[4×4,3], B[4×4,6], B[4×4, 7], and the 16×8 block of FIG. 6 is referred to as B[16×8,8].

Since the macroblock illustrated at FIG. 6 only has six blocks, only six block buffers of its corresponding macroblock buffer will be allocated. The block buffer to be allocated to a block of a macroblock is selected based upon the top-left most 4×4 location of the block. Therefore, for the macroblock of FIG. 6, information for block B[8×8,0] would be stored at block buffer BB0, information for block B[4×4,2] would be stored at block buffer BB_2, information for block B[4×4,3] would be stored at block buffer BB_3, information for block B[4×4,4] would be stored at block buffer BB_4, information for block B[16×8,8] would be stored at block buffer BB8. Since there are no other blocks in the macroblock of FIG. 6, the other available ten block buffers of the macroblock buffer are not allocated, and, therefore, are not used to store information for the macroblock of FIG. 6.

FIG. 7 illustrates a particular embodiment of a more detailed implementation of a neighbor block control module module, such as neighbor block control module 115 of FIG. 2. neighbor block control module 115 includes a client buffer controller 21 connected to parser 1131 by interconnect 210, a client buffer controller 22 connected to entropy coder 1132 by interconnect 220, a client buffer controller 23 connected to motion vector prediction module 1133 by interconnect 230, and a macroblock management module 26 connected to each of the clients 1131-1133 by interconnect 240 and to each of the client buffer controller modules 21-23 (not shown). Each of the client buffer controllers 21-23 and the macroblock management module 26 are connected to access memory 15.

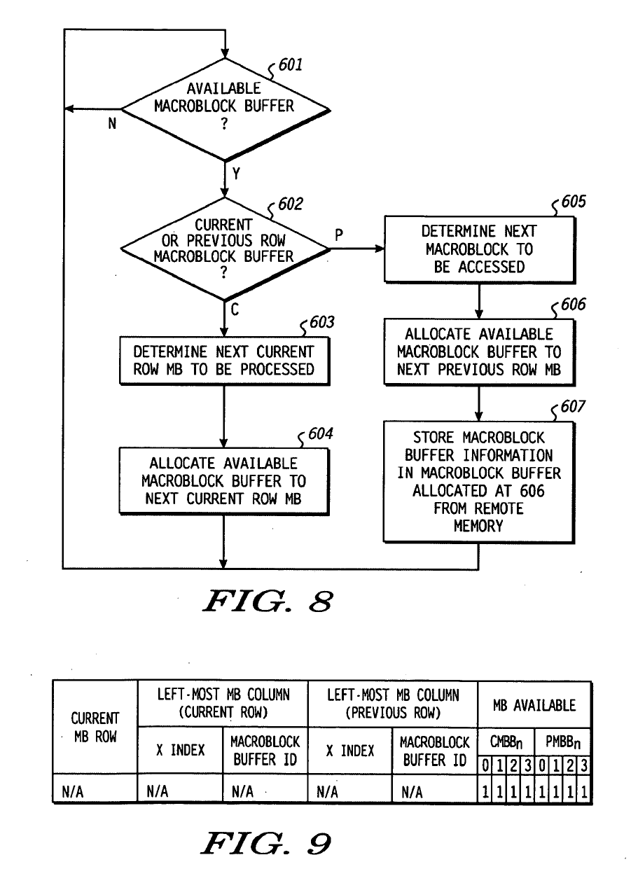

During operation, the macroblock management module 26 allocates and de-allocates macroblock buffers 152 at memory 15 based upon information received from the clients of the neighbor block control module 115. For example, the macroblock management module 26 can receive register information indicating a state of the neighbor block's clients, and because each client of neighbor block control module 115 operates in a known manner, macroblock management module 26 use this information to allocate and load macroblock buffers with information prior to the clients needing to access the macroblock buffers. Operation of macroblock management module 26 will be better understood with reference to FIG. 8.

FIG. 8 illustrates a flow diagram that represents a method of operation of the macroblock management module 26 in accordance with a particular embodiment of the present disclosure. At flow control node flow control node 601 it is determined if one of the macroblock buffers 152 is available to be allocated to a macroblock of a picture being processed. Whether a macroblock buffer is available can be determined based upon information stored at buffer status memory 24 of memory 15. FIG. 9 illustrates a buffer status table that indicates status information for a macroblock buffers 152 stored at buffer status memory 24 of neighbor block control module 115 prior to any of the macroblock buffers (CMBB0-CMBB4 and PMBB0-PMBB4) being allocated.

The macroblock buffer status table of FIG. 9 includes information identifying the current row of macroblocks being processed stored in the column labeled CURRENT MB ROW. Information identifying the left-most macroblock of the identified current row allocated to a current row macroblock buffer is stored in the column labeled X Index/ LEFT-MOST MB COLUMN (Current Row). The identified left-most macroblock of the current row is allocated to the macroblock buffer indicated at the column labeled Macroblock Buffer/ LEFT-MOST MB COLUMN (Current Row). Information identifying the left-most macroblock of a previous row of macroblocks having a macroblock buffer allocated to it is stored in the column labeled X Index/ LEFT-MOST MB COLUMN (Previous Row). The identified left-most macroblock of the previous row is allocated to the macroblock buffer indicated at the column labeled Macroblock Buffer/ LEFT-MOST MB COLUMN (Current Row). Information identifying the availability of macroblock buffer CMBB0 is stored in the column labeled 0/CMBBn/AVAILABILITY. Information identifying the availability of macroblock buffer CMBB1 is stored in the column labeled 1/CMBBn/AVAILABILITY. Information identifying the availability of macroblock buffer CMBB2 is stored in the column labeled 2/CMBBn/AVAILABILITY. Information identifying the availability of macroblock buffer CMBB3 is stored in the column labeled 3/CMBBn/AVAILABILITY. Information identifying the availability of macroblock buffer PMBB0 is stored in the column labeled 0/PMBBn/AVAILABILITY. Information identifying the availability of macroblock buffer PMBB1 is stored in the column labeled 1/PMBBn/AVAILABILITY. Information identifying the availability of macroblock buffer PMBB2 is stored in the column labeled 2/PMBBn/AVAILABILITY. Information identifying the availability of macroblock buffer PMBB3 is stored in the column labeled 3/PMBBn/AVAILABILITY.

Referring back to flow control node 601 of FIG. 8, the macroblock management module 26 would determine, based upon the information stored at buffer status table of FIG. 9, that there are macroblock buffers available for allocation, as each macroblock buffer represented in the availability column of FIG. 6 has a corresponding availability indicator of 1, indicating it is not currently allocated to a macroblock. For example, a 1 is stored at the column labeled 2/CMBBn/AVAILABILITY indicates macroblock buffer CMBB2 is available for allocation.

When there is a macroblock available for allocation, macroblock management module 26 will select the next available macroblock buffer from one of the current row of macroblocks buffers 1522 or the previous row of macroblock buffers 1521 for allocation before transitioning to flow control node 602. Note the macroblock buffers for a specific row of macroblock buffers are allocated in a modulo manner starting with the macroblock buffer having the lowest numeric suffix, e.g., CMB0, and continuing to the macroblock buffer having the largest numeric suffix, CMB4, before repeating. Therefore, if multiple macroblock buffers for a row are available for allocation the next macroblock buffer in the module order will be selected for allocation. For purposes of illustration, it is assumed macroblock buffer CMBB0 has been selected for allocation.

At flow control node 602 it is determined whether the macroblock buffer being allocated, e.g., the selected macroblock buffer from flow control node 601, is a member of the current row macroblock buffers, e.g., a member of the set of macroblock buffers 1522, or the previous row macroblock buffers, e.g., a member of the set of macroblock buffers 1521. Flow proceeds to 603 if the macroblock buffer being allocated is a current row macroblock buffer. Flow proceeds to node 605 if the macroblock buffer being allocated is a previous row macroblock buffer.

At node 603, a next macroblock of the current row of macroblocks that is not already allocated to a macroblock buffer is determined. For example, as soon as a new picture to be processed is identified the macroblock management module 26 will determine that the first macroblock of the new picture is the next macroblock to be processed. For example, the first macroblock of the picture of FIG. 4 is MB[1,1], and therefore would have been identified at node 603. Note the macroblock management module 26 can identify that a new picture is to be processed by monitoring information available to MPE 104 indicating a picture to be processed, or by monitoring client specific information, such as information at the client's registers.

At node 604, the selected macroblock buffer is allocated to the macroblock identified at node 603.

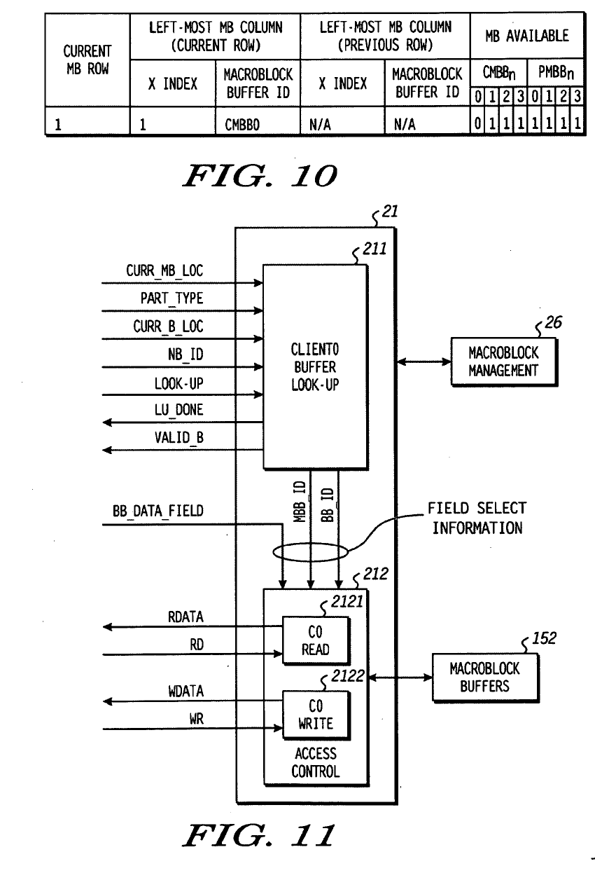

FIG. 10 illustrates the macroblock buffer status table of FIG. 9 after being updated in response to the macroblock management module 26 allocating the macroblock buffer identified at flow control node 601, macroblock buffer CMMB0, to the macroblock MB[1,1], which was identified at node 603. As part of allocating a macroblock buffer to correspond to the identified macroblock, the macroblock management module 26 updates the macroblock buffer information table as follows: a 1 is stored in the column labeled CURRENT MB ROW to indicate that the current row of macroblocks being processed is macroblock row 1 of the picture; a 1 is stored in the column labeled X Index/ LEFT-MOST MB COLUMN (Current Row) to indicate the macroblock at column 1 of the current row (row 1) is the left-most macroblock of the current row having a macroblock buffer allocated to it; an indicator corresponding to macroblock buffer CMBB0 is stored in the column labeled MBB ID/ LEFT-MOST MB COLUMN (Current Row) to indicate the macroblock buffer allocated to the macroblock identified at the column labeled X Index/ LEFT-MOST MB COLUMN (Current Row); a 0 is stored at the column labeled 0/CMBBn/AVAILABLE to indicate that macroblock buffer CMBB0 is currently allocated, and therefore not available for allocation.

Once the macroblock buffer CMBB0 is allocated to macroblock MB[1,1] flow returns to flow control node 601 where it is determined whether there is macroblock buffer available for allocation. This process repeats its self with respect to current row macroblock buffers, CMBB0-CMBB4, until they are allocated to the first five macroblocks MB[1,1] through MB[5,1] of the picture.

Referring back to flow control node 601, when a previous row macroblock buffer is indicated as available at the buffer status table, the macroblock management module 26 will further determine whether a previous row of macroblocks exists relative to the current row. In the present example, where a new picture is being processed each of the prior row macroblock buffers are available for allocation and flow proceeds to node 602.

At flow control node 602 it is determined that the macroblock buffer being allocated, e.g., the selected macroblock buffer identified by flow control node 601, is a member of the previous row macroblock buffers, e.g., a member of the set of macroblock buffers 1521 and flow proceeds to node 605.

At node 605, a next macroblock to be allocated to the selected macroblock buffer is is determined. Based upon the present example, macroblock row 1 is the current row of macroblocks, whereby there is no previous row of macroblocks relative the current row of macroblocks. However, because the macroblock management module 26 understands operation of the bit stream engine, it knows that the current row of macroblocks will become the previous row of macroblocks once processing of the current row is completed. Therefore, the macroblock management module 26 determines that MB[1,1] is the next previous row macroblock, and identifies MB[1,1] as such, and flow proceeds to node 606.

At node 606 the identified previous macroblock buffer, e.g., PMMB0, is allocated to the identified macroblock, e.g., MB[1,1]. As part of allocating macroblock buffer CMBB0 to macroblock MB[1,1], the macroblock management module 26 updates the macroblock buffer information table as follows: a 1 is stored in the column labeled X Index/ LEFT-MOST MB COLUMN (Previous Row) to indicate that the macroblock at column 1 of the previous row, which will be row 1, is the left-most macroblock of the previous row having a macroblock buffer allocated to it; an indicator corresponding to macroblock buffer PMBB0 is stored in the column labeled MACROBLOCK BUFFER/ LEFT-MOST MB COLUMN (Previous Row) to indicate the macroblock buffer allocated to the macroblock identified at the column labeled X Index/ LEFT-MOST MB COLUMN (Previous Row); a 0 is stored at the column labeled 0/PMBBn/AVAILABLE to indicate that macroblock buffer PMBB0 is currently allocated, and therefore not available for allocation.

After allocation, flow proceeds to node 607 where stored macroblock buffer information is loaded into the just allocated previous macroblock buffer, e.g., PMBB0. The loaded macroblock buffer information was originally calculated by the neighbor block control module 115 clients and stored in a current macroblock buffer. As will be discussed below, the information stored at the current macroblock buffer is stored to a remote memory, once it is no longer needed. In the present example, the macroblock information to be stored at PMBB0 may not yet be generated, as current row processing of MB[1,1] may not yet have generated the information for CMBB0. Therefore, node 607 will wait to load the stored macroblock information until it is available at remote memory. From node 607 flow returns to flow control node 601.

How macroblock buffers 152 are accessed for clients will be better understood with reference to FIG. 11, which illustrates a portion of FIG. 7 including a more detailed implementation of the client buffer controller 21 of neighbor block control module 115 in accordance with a particular embodiment. The client buffer controller 21 includes a buffer lookup module 211, and an access control module 212. Also illustrated at FIG. 11 are buffer status memory 24 and buffers 152 memory 15 of memory 15.

Referring to FIG. 7, during operation, a client connected to the client buffer controller 21 will provide an access request as previously described that includes a lookup portion to indicate a desired picture block, and an access portion to access a field of the desired picture block. Information associated with the lookup portion of the request is referred to as lookup information and includes information that identifies a specific picture block, referred to as the identified picture block, and the neighbor block information. Referring to FIG. 11, the client indicates the identified picture block by providing a macroblock location indicator and block information. The macroblock location indicator is provided to the buffer lookup module 211 via the interconnect labeled CURR_MB_LOC, and includes information indicating a specific macroblock of a picture, referred to as an identified macroblock. For example the macroblock location indicator can include a macroblock row indicator and a macroblock column indicator. The identified macroblock contains the identified picture block, which is indicated by block information of the lookup portion that is provided to the buffer lookup module 211 via interconnect labeled CURR_B_LOC, and includes information indicating a specific block location of the macroblock. For example, a 4×4 location (0-F) of the identified block can be provided. In addition, the block information can also include a partition indicator via interconnect labeled PART_TYPE identifying the size (e.g., 4×4, 8×8, 16×16, 4×8, 8×4, 8×16, 16×8) of the identified picture block.

The neighbor block information of lookup portion of the request is provided to the buffer lookup module 211 at the interconnect labeled NB_ID. The neighbor block information can indicate that either the identified block or a neighbor block to the identified block is to be accessed. For example, the neighbor block information can have a value that indicates the identified block is to be accessed, or one of multiple values indicating a corresponding direction to an adjacent picture block, referred to as a neighbor block direction. For purposes of discussion, the following nomenclature is used to represent various indicators corresponding to neighbor block information: the identified block (IB); the block to the left (L) of the identified block; the block to the top-left (TL) of the identified block; the block to the top (T) of the identified block; and the block to the top-right (TR) of the identified block.

The information below corresponds to lookup information provided by a client that writing information at a block buffer that corresponds to the picture block it is currently processing.
CURR_MB_LOC: [1,1];
   PART_TYPE: 4×4
CURR_B_LOC: 0
   NB_ID: IB

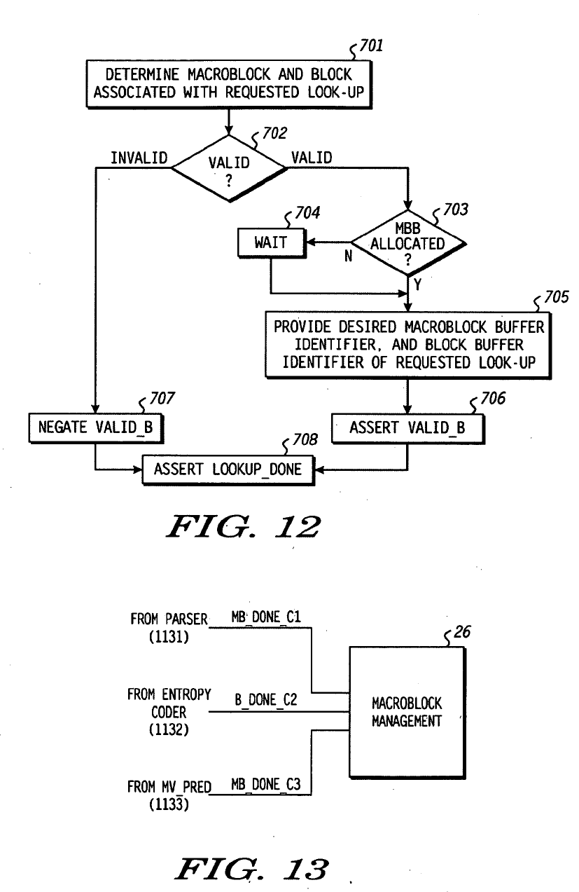

After asserting the above information at the indicated interconnects, the client will assert a signal at the interconnect labeled LOOKUP to indicated to the buffer lookup module 211 to process the lookup information. In response, the client buffer lookup table will determine that the desired picture block is the 4×4 block at the top-left most 4×4 location of MB[1,1]. As indicated above, the desired block is the block being currently processed by the client. The operation of the client buffer lookup module 211 will be better understood with reference to the method indicated by the flow chart of FIG. 12.

At node 701 of FIG. 12, the buffer lookup module 211 will apply the neighbor rules for a specific video standard to determine the desired picture block based upon the lookup information. While the indicators at CURR_MB_LOC, CURR_B_LOC, and PART_TYPE identify a block of the picture being processed by the client, the value of NB_ID determines whether that block or an adjacent block, referred to as a neighbor block, is the desired block. For example, the indicator IB at NB_ID of the above lookup information indicates that the desired picture block is the same as the identified picture block.

However, if the above lookup request had an indicator of L at NB_ID, instead of an indicator of IB, the desired picture block would not be the identified block, but a neighbor block of the identified block. As a result, the buffer lookup module would apply a set of neighbor rules for the current video standard to determine the desired block.

For purposes of discussion, the set of neighbor rules being applied are assumed identify a neighbor block to the left of the identified picture block in response to a neighbor block direction indicator L, a neighbor block to the right of the identified picture block in response to a neighbor block direction indicator R, a neighbor block to the top-left of the identified picture block in response to a neighbor block direction indicator TL, a neighbor block to the top of the identified picture block in response to a neighbor block direction indicator T, a neighbor block to the top-right of the identified picture block in response to a neighbor block direction indicator TR.

Therefore, referring to FIG. 6, the identified picture block is block B[8×8,0], and the neighbor block direction indicator is L, whereby the buffer lookup module 211 will determine that the macroblock, e.g., the desired macroblock, containing the desired picture block is a macroblock to the left of the macroblock of FIG. 6 (not illustrated), and would access partition information stored at a macroblock buffer allocated to the desired macroblock to determine the desired picture block.

Note that if the identified block were block B[4×4,2] of the macroblock of FIG. 6, instead of B[8×8,0], the desired block would be block B[8×8,0] illustrated at FIG. 6.

It will be appreciated that just as the neighbor rules can vary based upon the video standard used to encode the picture being processed, the operation of the various processing modules, such as bit stream acceleration module 106 and the video processing module 108 can vary their operation based upon the video standard used to encode the picture being processed. Their operation can be varied by utilizing different hardware or software, e.g., firmware. Software used to vary operation based upon the indicated standard can be stored at an integrated circuit, referred to as on-chip, that also includes the MPE 104, or accessed from off-chip.

At flow control node 702 of FIG. 12, a decision is made whether the requested block as determined at node 701 is a valid block. For the above listed lookup information, having a neighbor block direction indicator of IB, the requested block is block B[0] of macroblock MB[1,1], which is a valid block and flow proceeds to flow control node 703. Note, however, that had the neighbor block direction indicator been L, instead of IB, thereby indicating a neighbor block to the left of macroblock MB[1,1], the requested block would need to be in a macroblock to the left of MB[1,1]. However, since no such macroblock exists the lookup request is considered invalid. When the lookup portion of the request is invalid, the flow proceeds to node 709 where a negated valid signal is asserted at interconnect VALID_B to indicate the lookup information resulted in an invalid picture block being identified. Flow then proceeds to node 708.

At flow control node 703 of FIG. 9, a determination is made whether or not a macroblock buffer has been allocated for the requested macroblock. If not, flow proceeds to node 704, otherwise flow proceeds to node 708.

At node 704 the requesting client waits until a macroblock buffer has been allocated to the requested macroblock by the macroblock management module 26.

At node 705, information is provided to the access control module 21 that identifies the block buffer allocated to the desired block buffer. For example, a macroblock buffer identifier indicating macroblock buffer CMBB0 is provided to interconnect MBB_ID, and a block buffer identifier of 0 is provided to interconnect BB_ID. Referring to FIG. 3, this information, referred to as desired block select information, is used to select block buffer BB0 of macroblock buffer CMBB0 for access.

From node 705 flow proceeds to node 706 of FIG. 12, where a valid signal is asserted at interconnect VALID_B to indicate the lookup information resulted in a valid picture block being identified, and flow proceed to node 708. For example, referring to FIG. 11, the buffer lookup module 211 asserts the signal VALID_B so that the client knows that the desired block as indicated by lookup information is a valid block.

At node 708, a signal is asserted by the buffer lookup module 211 at interconnect LU_DONE so that the requesting client knows that the lookup portion of its request has been completed. If the lookup was valid, the client buffer controller 21 has selected a block buffer, referred to as the active block buffer, and read and write access requests from the client can be successfully processed by access control module 212 of the client buffer controller 21. If the lookup was not valid, read and write access requests from the client can not be successfully processed by access control module 212 of the client buffer controller 21

After receiving an asserted LU_DONE indicator, the client can complete an access portion of an access request by providing read and write requests identifying specific fields of the selected block buffer. For example, the client can request a field location of the active block buffer be read by providing a signal to access control module 212 via node BB_DATA_FIELD indicating the field of the active buffer to be read, and by asserting a read signal to access control module 212 via node RD indicating that the control module can access the field indicated at node BB_DATA_FIELD. In response, access control module 212 will provide the data at the indicated field to the interconnect RDATA.

Similarly, the client can request a field location of the active block buffer be written to by: providing a signal to access control module 212 via node BB_DATA_FIELD indicating the field of the active buffer where information is to be written; providing information to be stored at interconnect WDATA; and asserting a write signal to access control module 212 via node WR indicating to the access control module of the client buffer controller 21 that the information at interconnect WDATA can be stored at the indicated field of the active buffer.

In this manner, a plurality of clients submit multiple access request to neighbor block 115 to store macroblock data at various fields of a block buffer. Note, that multiple read and write requests can be made by a client to access different locations of a block buffer for a single lookup request.

The number of macroblock buffers maintained in memory 15 is based upon the depth of the pipeline formed by the block's clients, and the operation of each client. For example, the clients to neighbor block control module 115 at bit stream engine 113 can simultaneously process picture blocks from the same macroblock, as well as from different macroblocks. For example, for purposes of discussion, it is assumed that the parser module 1131, the entropy coder 1132, and the MV_PRED module 1133 can be processing three sequential macroblocks simultaneously, thereby requiring the macroblock buffer depth of each row of macroblock buffers to be at least three. In addition to pipeline depth the information needed to process a macroblock also affects the macroblock buffer depth. For example, if the MV_PRED module needs previously stored information from its previously processed neighbor blocks, the macroblock buffers containing the needed information also need to be maintained. Therefore, by taking into account how many macroblocks can be simultaneously processed, and when information stored at a macroblock buffer will be needed and for how long it will be needed, the depth of the macroblock buffers can be determined.

For example, referring to neighbor block 21, once a macroblock buffer is allocated by the client buffer lookup module 211, the macroblock remains allocated until each of the clients to the neighbor block buffer 21 indicates the macroblock is no longer needed. For example, when a client no longer needs a macroblock, it will assert a corresponding signal that is provided to the macroblock management module 26. Referring to FIG. 13, an asserted signal is provided by the parser module 1131 to an input of the macroblock management module 26 via node MB_DONE_C1 to indicate to the neighbor block control module 21 that the parser module 1131 no longer needs to access information stored at a macroblock buffer to complete processing of a current row. The macroblock management module 26 of the neighbor block control module 21 keeps track for each macroblock buffer, clients have indicated their information is no longer to process the current row. When all clients are done with a macroblock buffer, the macroblock buffer is de-allocated by macroblock management module 26.

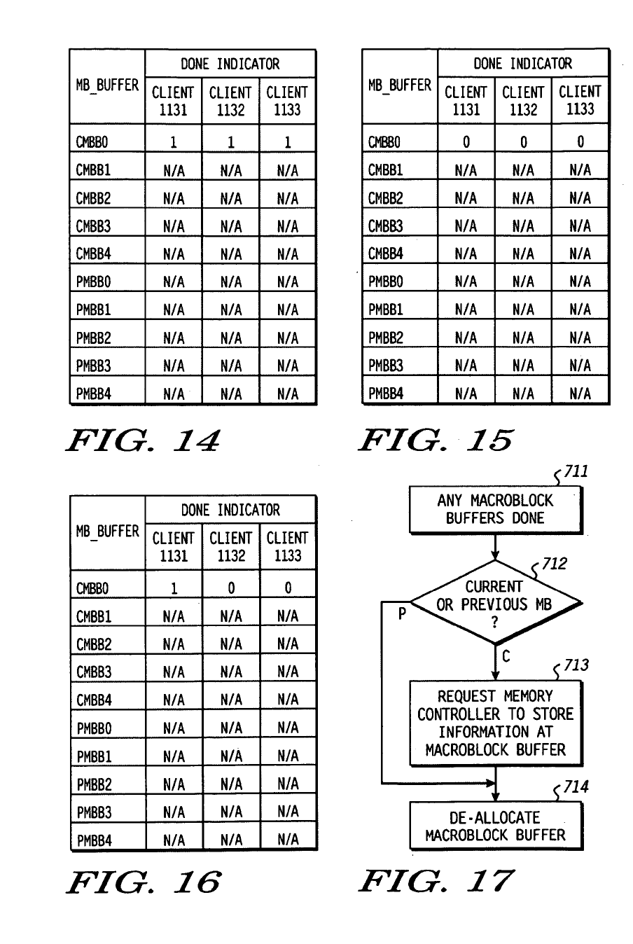

For example, FIG. 14 illustrates a de-allocation table representing information maintained by the macroblock management module 26 prior to any macroblock buffers being allocated by the neighbor block module 21. The first column of the macroblock de-allocation table lists each macroblock buffer of the neighbor block module 21. The second column indicates whether the parser module 1131 is done with the macroblock buffer indicated at column 1. The third column indicates whether the entropy coder 1132 is done with the macroblock buffer indicated at column 1. The fourth column indicates whether MV_PRED 1133 is done with the macroblock buffer indicated at column 1. An indicator of N/A at the de-allocation table indicates a macroblock buffer corresponding to the value is not allocated. An indicator of 1 at the de-allocation table indicates a corresponding client no longer needs the information stored at the corresponding macroblock buffer to complete processing of a current row of macroblocks. An indicator of 0 at the de-allocation table indicates a corresponding client needs the information stored at the corresponding macroblock buffer to complete processing of a current row of macroblocks. Therefore, because none of the macroblock buffers are currently allocated, each field of each row contains the indicator N/A.

With respect to an example where CMBB0 is the first macroblock to be allocated, the de-allocation table of FIG. 14 will be updated as indicated by the de-allocation table of FIG. 15 immediately after allocation of buffer CMBB0. The done indicator for each of the three clients with respect to macroblock buffer CMBB0 is 0, which indicates each of the three clients still need to access the macroblock buffer CMBB0.

Referring back to FIG. 13, when an asserted signal is received from node MB_DONE_C1, the macroblock management module 26 21 will determine that parser 1131 no longer needs information stored at macroblock buffer CMBB0 to processes the current macroblock row, and will store an indicator of 0 at the de-allocation table corresponding to CMBB0 and parser 1131, as illustrated at FIG. 16.

Further operation of the de-allocation module 26 will be better understood with reference to the flow chart of FIG. 17. At node 711, a determination is made whether all clients are done with any of the allocated macroblock buffers, and therefore available for de-allocation. In the current example, none of the macroblock buffers are available for de-allocation.

However, when it is determined that all of the clients are done with one of the allocated macroblocks, flow proceeds to node 712 where a determination is made whether the macroblock buffer that is no longer needed is a current row macroblock buffer or a previous row macroblock buffer. If the macroblock buffer is a previous row macroblock buffer flow proceeds to node 714. If the macroblock buffer is a current row macroblock buffer flow proceeds to node 713.

At node 713, the macroblock management module 26 provides a request to a memory controller, such as memory controller 130 of FIG. 1, to store the information at the macroblock buffer that is no longer needed to memory that is not local to the neighbor block module. For example, the memory controller will store the information at memory 131 By storing macroblock information from the macroblock buffers of the current row in non-local memory, the macroblock information that was written to the macroblock buffer during processing of the macroblock buffer can be maintained for subsequent use by the clients that generated the information. For example, processing of a current macroblock can require information related to a macroblock of a previous row be used. Therefore, by saving the contents of the current row macroblock buffers at non-local memory, the macroblock buffer information generated by the clients during the processing of a current row can be retrieved as prior row information when a different row is being processed as will be discussed further herein. Once the contents of the macroblock buffer that is no longer needed by the clients have been written to memory at node 713, flow proceeds to node 714, where the macroblock management module 26 updates the macroblock buffer status table at buffer status memory 24 to indicate the macroblock buffer being de-allocated is available for allocation.

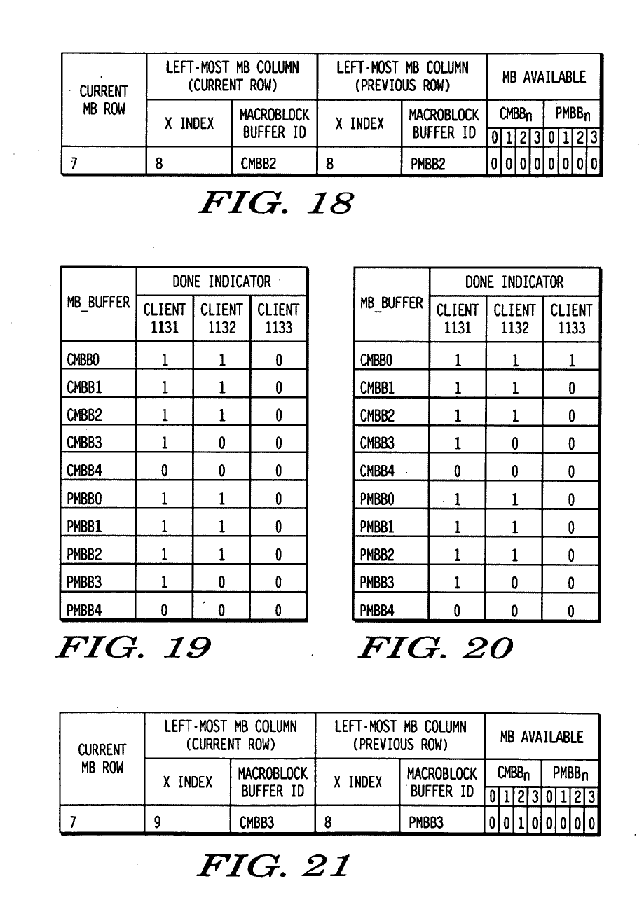

The interaction between a neighbor block 21 and its clients will be better understood by way of example. General operation of the neighbor block module 115 will be now discussed with reference to FIG. 4, which illustrates the macroblocks of a picture, whereby the macroblock locations of the picture that have a corresponding allocated macroblock buffer are designated by bold borders. Therefore, previous row macroblock buffers have been allocated to macroblocks MB[8,6] through MB[12,6], which are associated with macroblock row 6 that was previously processed by the parser 1131, and current row macroblock buffers have been allocated to macroblocks MB[8,7] through MB[12,7], which are associated with macroblock row 7 that is currently being processed by the parser 1131. The graphical information at FIG. 4 is consistent with the macroblock buffer status table illustrated at FIG. 18. Note that application of the information at FIG. 18 as previously discussed indicates that the left-most macroblock of row 7 has been allocated to macroblock CMBB2, and that the left-most macroblock of row 6 has been allocated to macroblock PMBB2.

FIG. 19 illustrates a de-allocation table indicating the status of the macroblock management module 26 at the same time, referred to as time T1, as the macroblock buffer status table of FIG. 18 represents the status of the macroblock buffers. FIG. 19 indicates that, the motion vector prediction client 1133 still needs information from all of the macroblock buffers. For example, the motion vector prediction module 1133 is still processing macroblock MB[9,7] and needs information related to the previous row macroblocks MB[8,6], MB[9,6], and MB[9,6], and information related to the current row macroblock MB[8,7] to complete motion vector prediction processing for macroblock MB[9,7].

Subsequent to time T1, the motion vector prediction module 1133 retrieves the last information it needs from the macroblock buffer allocated to macroblock MB[8,7] needed to complete processing of the current row and asserts a signal at node MB_DONE_C3 to notify the macroblock management module 26. In response, de-allocation table of FIG. 19 will be updated as indicated at FIG. 20, to store an indicator of 1 at the table entry common to the row labeled CMBB1 and the column labeled CLIENT 3. Note that MB[8,7] is the left-most macroblock of the current row as indicated by the table information of FIG. 18.

In response to the information at FIG. 20 indicating that each of the clients are done with macroblock buffer CMBB2, the macroblock management module 26 will determine at node 711 of the flow chart of FIG. 17, that information at macroblock buffer CMBB2 is not currently needed by any client, and flow will proceed to node 712.

At node 712 a determination is made that the macroblock buffer that is no longer needed to complete processing of the current row is a current row macroblock buffer, whereby flow proceeds to node 713. It is noted that information stored at macroblock buffers of the current row is still needed to complete processing of the picture. At node 713, the macroblock management module 26 provides a request to memory controller 30 to store the information at macroblock buffer CMBB2. The flow proceeds to node 714 upon completion of the request to store the information at CMBB2 elsewhere. At node 714, the macroblock management module 26 updates the macroblock buffer status table to indicate the macroblock buffer associated with the left most macroblock of the of the current row, MB[9,7], is macroblock buffer CMBB3 as indicated at FIG. 21.

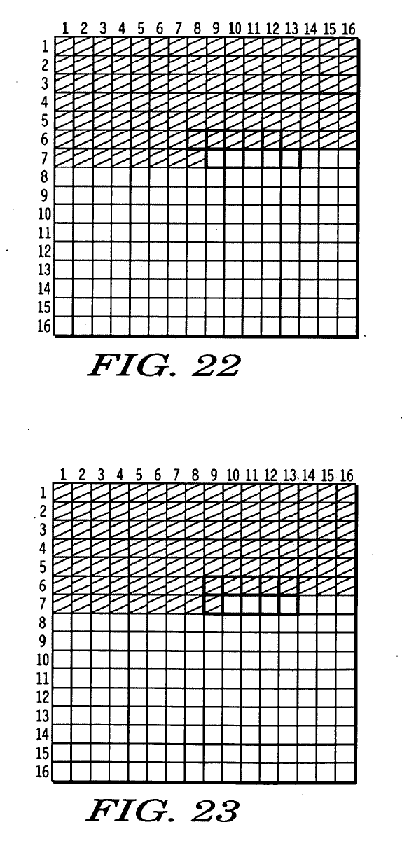

Once de-allocated, macroblock buffer CMBB2 is available to be allocated to macroblock MB[13,7] by client buffer lookup controller 211, as previous described with reference to the method of FIG. 8. FIG. 22 graphically represents the macroblock buffer status subsequent to macroblock buffer CMBB2 being allocated to MB[13,7].

Referring back to flow control node 712 of FIG. 17, when the macroblock buffer that is no longer needed is a previous row macroblock the flow proceeds directly to node 714 for de-allocation, as its contents are no longer needed to complete processing of the current picture, or its contents are already saved.

The macroblock buffer PMBB2 will be de-allocated by macroblock management module 26 when the motion vector prediction module 1133 indicates it is done with information at macroblock buffer PMBB2 after it has retrieved the last information from PMBB2. Note that PMBB2 is initially allocated to MB[8,6], and subsequently allocated to macroblock MB[13,6], as graphically illustrated by FIG. 23, which represents a time T3. In this manner, a sliding window of macroblock buffers is implemented. Note that at time T3 the motion vector prediction module 1133 has completed processing of macroblock MB[9,7], and therefore is shaded.

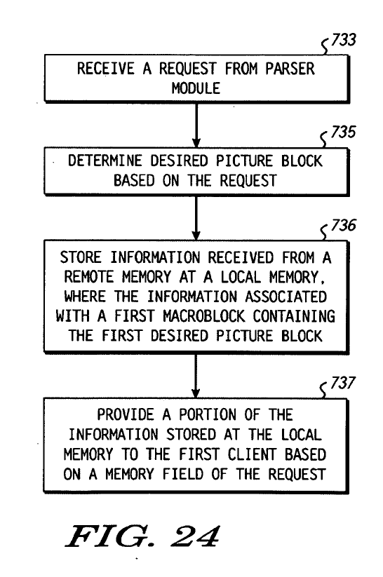

At a time T3, the motion vector prediction module 1133 has completed processing of macroblock MB[9,7] and begins processing macroblock MB[10,7]. FIG. 24 illustrates the partitioning of macroblocks of FIG. 23 that will be accessed by motion vector prediction module 1133 during the processing of MB[10,7]. Macroblocks MB[9,7] and MB[10,7] each have sixteen 4×4 blocks. Macroblock MB[9,6] has three blocks: B[16×8,0], B[8×8,8], and B[8×8,A]. Macroblock MB[10,6] has one block: B[16×16,0]. Macroblock MB[11,6] has two blocks: B[8×16,0], and B[8×16,2]. Therefore, macroblock buffers are already allocated to each macroblock having information that is needed to process macroblock MB[10,7].

It will be appreciated that by allocating and de-allocating macroblock buffers in this way, a client does not have to spend time applying neighbor block rules to determine a desired macroblock. Removing this requirement from a client allows the client to operation more efficiently. For example, a client implanted in hardware would not require the additional circuitry to determine the desired neighbor block, while a client implemented in software would not need to spend processing time calculating the desired neighbor block, thereby allowing faster operation. It will be appreciated that removing the overhead of calculating the desired block from a client can allow a client to be implemented in software that would otherwise be implemented in hardware to facilitate a desired processing speed.

It will be appreciated that by maintaining macroblock buffers for the current and previous rows at memory 25, it is possible for neighbor clients of the neighbor block to store and retrieve macroblock information needed to process macroblocks of a picture without having to access memory 131 through memory control module 130, which would take significantly longer than accessing macroblock information at the memory 15. In other words, the physical relationship of a client to its neighbor block, and the neighbor block to its local memory 15 is such that a client can access memory local to the neighbor block quicker than it can access memory via memory control module 130. It will also be appreciated, that by maintaining a limited number of macroblock buffers, the cost of implementing the macroblock buffers is lower than if the reconstruction data determined at the clients were stored at on-chip memory for an entire picture.

FIG. 24 illustrates a flow diagram representing a method in accordance with a particular embodiment. At node733, a request is received at the neighbor block control module 115 from the parser module 1131. The request can be an access request to access information associated with a desired picture block. The access request can include a lookup portion and an access portion as previously described.

At node 735 the desired picture block is determined as previously discussed at 601 of FIG. 8. It will, however, be appreciated that that a set of neighbor rules used to determine the desired picture can be selected from a plurality of sets of neighbor rules, one for each video protocol implementing neighbor rules. The set of neighbor rules selected can be based upon information stored at a memory location of an electronic device formed on a common substrate that includes the video processing system of FIG. 1.

At node 736, information received from a remote memory is stored as discussed with reference to node 713 of FIG. 17, where the remote information, such as from memory 31, is loaded to a recently allocated macroblock buffer. This information can be stored prior or subsequent to receiving the request at node 733.

At node 737 a portion of the information stored at the local memory is provided to the parser module 1131 in response to the request received at the neighbor block. For example, the request can be a read request from the parser module 1131 to access a specific field of a buffer block that is allocated to picture block being processed by the access control portion.

While the invention has been described in the context of a preferred embodiment, various modifications will be apparent to those skilled in the art. For example, various portions of the description herein describe decoding video data. However, it should be understood that one skilled in the art can use the teachings of the invention to decode and encode video data, audio data, or any combination thereof. Accordingly, it is intended by the appended claims to cover all modifications of the invention that fall within the true scope of the invention.

The term interconnect is used here generally and it will be appreciated that an interconnect can be an inactive structure such as one or more conductive nodes that transmit signals between modules, or an active structure such as a FIFO or other buffering mechanism.

It will be appreciated that the partitioning of functions between the various modules disclosed herein is for illustrative purposes unless specifically indicated. Also, additional or fewer neighbor block directions can be implemented depending upon the video standards supported. Examples of different neighbor block directions includes top-top (TT), top-top-left (TTL), top-top-right, top-left-left (TLL).

Examples of pictures as used herein have been with reference to entire video frames. However, the term picture as used herein is intended to be broadly so as to include picture frames, picture fields, picture slices, and the like. With respect to a picture slice, the availability of a macroblock can be based upon the availability of that macroblock being within the boundary of the picture slice boundary.

1. A method of processing video data comprising:
receiving, from a first client, a first request at a first memory control module, the first request identifying a first picture block of a picture, a first neighbor block direction, and a first memory field, where the first memory control module is local to the first client;
determining, at the first memory controller module, a first desired picture block based upon the first picture block, the first neighbor block direction, and a first set of neighbor rules, wherein the first desired picture block is a neighbor block of the first picture block;
storing first information received from a second memory, which is not local to the first memory control module, at a first memory, which is local to the first memory control module, where the first information is associated with a first macroblock containing the first desired picture block; and
providing a first portion of the first information stored at the first memory to the first client based on the first memory field.

2. The method of claim 1 wherein the first picture block identified by the first request is the picture block being processed by the first client.

3. The method of claim 1 further comprising:
selecting the first set of neighbor rules from a plurality of sets of neighbor rules based upon a value stored at a memory location of an electronic device, the electronic device includes the memory location, the first client, where the first memory controller, and the first memory integrated at a common semiconductor substrate.

4. The method of claim 1, wherein the first request includes an identifier identifying a first macroblock row and a first macroblock column of the picture containing a second macroblock, wherein the second macroblock is different than the first macroblock.

5. The method of claim 4, wherein information of the first request identifying the first picture block identifies a 4×4 partition identifier identifying a 4×4 set of pixels within the second macroblock.

6. The method of claim 1 further comprising:
receiving, at the first memory control module, the first information from a plurality of clients prior to receiving the request; and
storing the received first information at the first memory prior to storing the first information being received from the second memory, and prior to receiving the request, where the plurality of clients includes the first client.

7. The method of claim 6, wherein the first information includes partition information for the blocks of the first macroblock.

8. The method of claim 6, wherein the first request includes a row identifier identifying a first macroblock row of the picture containing a second macroblock and a first macroblock column containing the second macroblock, wherein the second macroblock is different than the first macroblock.

9. The method of claim 8, wherein the first information includes partition information for the blocks of the first macroblock.

10. The method of claim 6, wherein storing the received first information at the first memory further comprises storing the received first information in response to the plurality of clients no longer needing the first information to process a second macroblock row of the picture, where the second macroblock row includes the first desired picture block and is processed by the first client prior to the first macroblock row.

11. The method of claim 6, wherein the receiving the first information from the plurality of clients occurs when the plurality of clients are processing the first macroblock, and receiving the first request occurs when the first client is processing a second macroblock that includes the first picture block, the second macroblock being different than the first macroblock.

12. The method of claim 11, wherein storing the received first information at the first memory further comprises storing the received first information in response to the plurality of clients no longer needing the first information to process a second macroblock row of the picture, where the second macroblock row includes the first desired picture block and is processed by the first client prior to the first macroblock row.

13. The method of claim 1, wherein the first request includes a lookup portion and an access portion, where the lookup portion identifies the first picture block and the first direction, the access portion identifies the first memory field, and where the lookup portion of the request occurs prior to the access portion of the request.

14. The method of claim 13 further comprising:
determining, at the first client, that the lookup portion of the first request was valid, and providing the access portion of the request in response to determining the lookup portion of the first request was valid.

15. The method of claim 1, wherein storing the first information occurs prior to receiving the first request.

16. The method claim 1, wherein storing the first information occurs in response to receiving the first request.

17. A device comprising:
a first client;
a second client;
a first memory;
a second memory;
a first memory controller connected to the first memory;
a second memory control module connected to
the first client to receive first information related to a picture block being processed by the device,
the second client to receive second information related to the picture block being processed by the device,
the second memory to store the first and second information in response to being received from the first and second clients, where the second memory is local to the second memory controller, and the first memory is not local to the second memory controller;
the first memory controller to store the first and second information to the first memory in response to the first and second client indicating the first and second information is no longer needed to process a current row of an image.

18. The device of claim 17, wherein second memory control module is further connected to the first memory controller to retrieve the first and second information for access by the first client and the second client.

19. The device of claim 17 wherein the second memory control module comprises a buffer control module to apply a set of neighbor rules to identify a first desired picture block that is a neighbor to a first picture block identified by the first client, and to apply the set of neighbor rules to identify a second desired picture block that is a neighbor to a picture block identified by the second client

20. A method comprising:
receiving, at a first module, first macroblock data associated with a first macroblock, where the first macroblock is a macroblock of a first plurality of macroblocks of a first common row of macroblocks of a picture; and
at a second module:
receiving, from a plurality of clients at the first module, a first plurality of requests to store second macroblock data associated with the first macroblock, where each respective request of the first plurality of requests is to store data that is based upon the first macroblock data;
storing, in response to the first plurality of requests, the second macroblock data at a first macroblock buffer of a first plurality of macroblock buffers identified by a first index value provided by the first plurality of requests, and where the first plurality of macroblock buffers are local to the first module and each respective macroblock buffer of the first plurality of macroblock buffers stores macro block data corresponding to different immediately sequential macroblocks and where macroblocks of the first plurality of macroblocks buffers are immediately adjacent to each other in raster order;
requesting, at a first time, a memory controller to store the data at the first macroblock buffer, where the memory controller is to store the second macroblock data at a memory that is not local to the first module in response to the request to the memory controller;
requesting, at a second time, the memory controller to retrieve the second macroblock data from the memory; and
storing, in response to requesting the memory controller to retrieve the second data, the second macroblock data at a first macroblock buffer of a second plurality of macroblock buffers, where the second plurality of macroblock buffers are local to the first module and each respective macroblock buffer of the second plurality of macroblock buffers corresponds to a different macroblock of a row of macroblocks previously processed by the first module, and where the second macroblock data at the first macroblock buffer of the second plurality of macroblocks is needed by the first plurality of clients to process the picture.
